(19) United States
(12) Patent Application Publication
(10) Pub. No.: US 2019/0196776 A1
(43) Pub. Date: Jun. 27, 2019

(54) Process and system for hearing impaired to hear sound at a movie venue

(71) Applicant: Paul Hoffman, Akron, OH (US)

(72) Inventor: Paul Hoffman, Akron, OH (US)

(21) Appl. No.: 15/853,696

(22) Filed: Dec. 22, 2017

(51) Int. Cl. G06F 3/16; G06F 3/0484

(52) U.S. Cl. CPC G06F 3/165; G06F 3/0482; G06F 3/04847

(57) ABSTRACT

The system uses an application for a smart phone that eliminates the need to provide additional devices to patrons and reduces cost of lost or dysfunctional devices. The system can utilize Bluetooth capabilities to connect to audio within the theater. The system will have zero sound bleed from surrounding theaters. The phone remains on silent mode and the screen is off to prevent disruptions. The system would work like a smartphone application.

### CROSS-REFERENCES TO RELATED APPLICATIONS (IF ANY)

None

### BACKGROUND

### 1. Field of the Invention

The present invention relates to a process for the hearing impaired and more particularly one that is used with movie venues.

### 2. Description of Prior Art

One in eight people in the United States (13 percent, or 30 million) Aged 12 years or older has hearing loss in both ears, based on standard hearing examinations. About 2 to 3 out of every 1,000 children in the United States are born with a detectable level of hearing loss in one or both ears. Approximately 324,200 people worldwide have received cochlear implants The Justice Department, in 2010 said it was a considering a rule that 50% of movie screens offer captioning and video description services Hearing loss is a major public health issue that is the third most common physical condition after arthritis and heart disease.

Individuals with hearing conditions attend movies, they often do not have the full theater experience or avoid theaters all together.

There is still room for improvement in the art.

### SUMMARY OF THE INVENTION

The current invention is system and application that lets an hearing impaired user search for theaters and allows the user to sync up with a movie that is showing. The user can choose an option of using an increased sound, closed caption or subtitles on their smart phone or tablet. The system uses an application that eliminates the need to provide additional devices to patrons and reduces cost of lost or dysfunctional devices. The system can utilize Bluetooth capabilities to connect to audio within the theater. The system will have zero sound bleed from surrounding theaters. The phone remains on silent mode and the screen is off to prevent disruptions

The system, in the preferred embodiment, would work like a smartphone application, this product would be available through the respective marketplace for smartphones.

The innovative process is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows an overview of how Users access the system;

FIG. 2 shows a sample of a login screen;

FIG. 3 shows a sample of a home screen;

FIG. 4 shows a location screen;

FIG. 5 shows a sample of a theater near the location;

FIG. 6 shows a sample sync option screen;

FIG. 7 shows the purchase tickets function;

FIG. 8 shows the sync with device function; and

FIG. 9 shows a sample of a profile screen.

### DESCRIPTION OF THE PREFERRED EMBODIMENT

There are a number of significant design features and improvements incorporated within the invention.

The current invention is a system and application 1 that lets an hearing impaired user search for theaters 400 and allows the user to sync up with movie that is showing. The user can choose an option of using an increased sound, closed caption or subtitles on their smart phone or tablet.

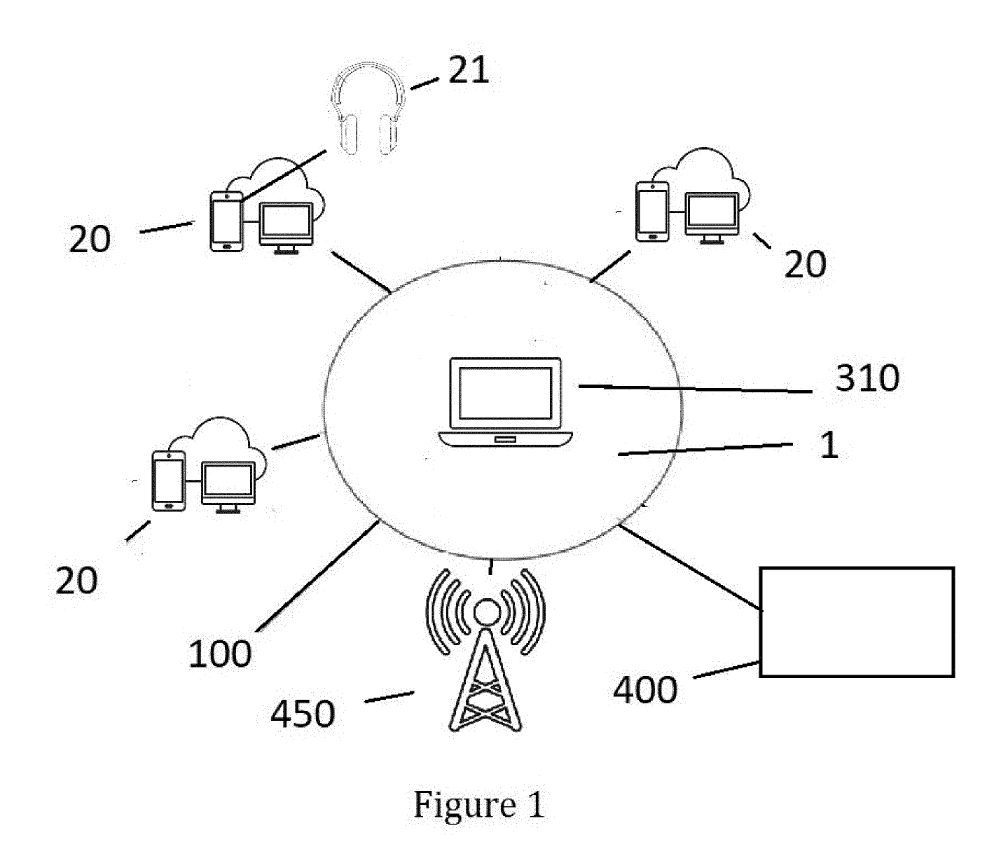

FIG. 1 displays the preferred embodiment of the system architecture 1 accessed through an Internet, Intranet and/or Wireless network 500. However, the system could be implemented on a device-to-device, wirelessly or client/server architecture as well.

In FIG. 1, the system 1 is accessed from a user's smart phone 20 through a web browser over HTTP and/or HTTPS protocols 500 or wireless network or cell phone to cell phone connection. A smart phone 20 that can access the system 1 must have some version of a CPU, CPU memory, local hard disk, keyboard/keypad/input and display unit. The smart phone 20 can also be replaced by another computing device such as a desktop, laptop, tablet or general purpose computing device with an appropriate amount of memory suitable for this purpose and an active connection to the Internet 500. Computing devices like this are well known in the art and are not pertinent to the invention.

The system 1, data and processing code can reside in the non-transitory memory 310 of the one or more computing devices. The system 1 in the preferred embodiment would be written to act like a smart phone application (app) where the different apps can communicate with each. The system 1 may work with a central server as shown in FIG. 1 or in parallel which each smart phone 20 communicating with others within the system 1. The smart phone 20 may be connected to a headset 25 or wireless earplugs. The system 1, data and processing code can reside in the non-transitory memory 310 of the one or more computing devices. The system 1 in the preferred embodiment would be written to act like a smart phone application (app). The system 1 can sync up with a movie or show at a movie theater 400.

Brief Overview

The system 1 uses an application for a smart phone 20 that eliminates the need to provide additional devices to patrons and reduces cost of lost or dysfunctional devices. The system 1 can utilize Bluetooth or other wireless 450 capabilities to connect to audio within the theater 400. The system 1 will have zero sound bleed from surrounding theaters. The phone 20 remains on silent mode and the screen is off to prevent disruptions. The sound would go to earphones 25 and in the preferred embodiment, noise cancelling earphones so that the sounds and dialogue from the desired movie will only be heard by the user.

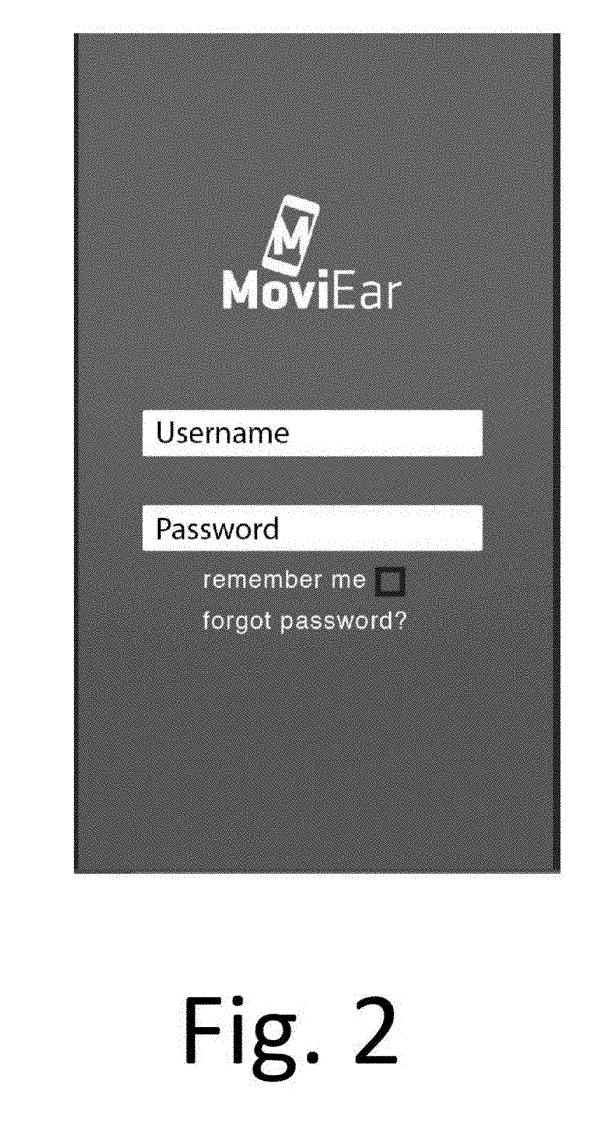

The users would sign-in directly or using social logins as shown in FIG. 2 with the user registering the app,

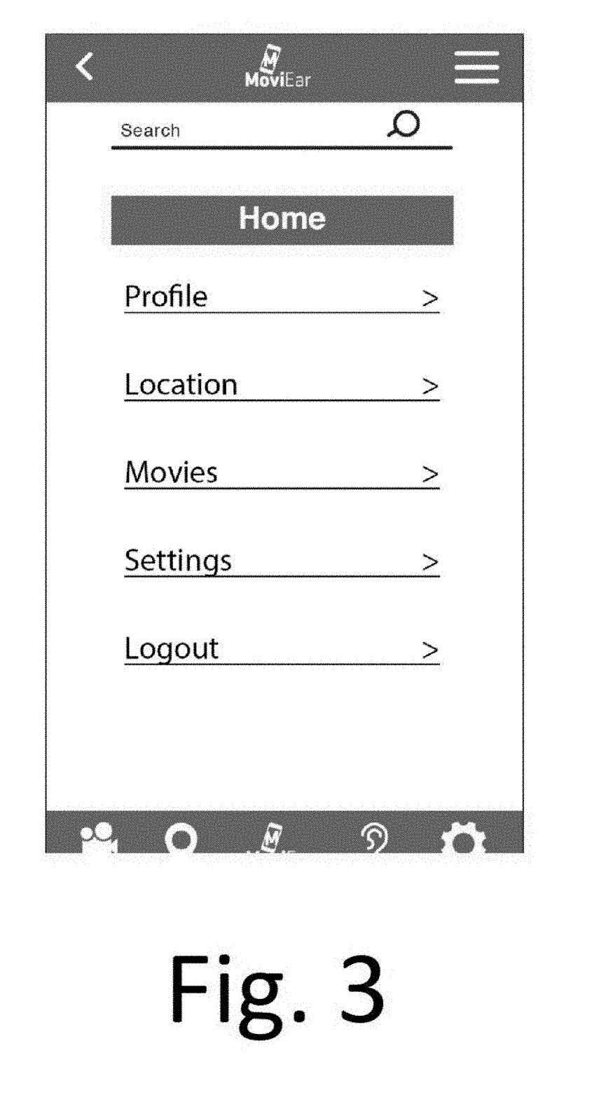

The system 1 will have a home page as shown in FIG. 3. The home page will connect the user to the functions and options of the system such as profile, location, movies, settings and log out.

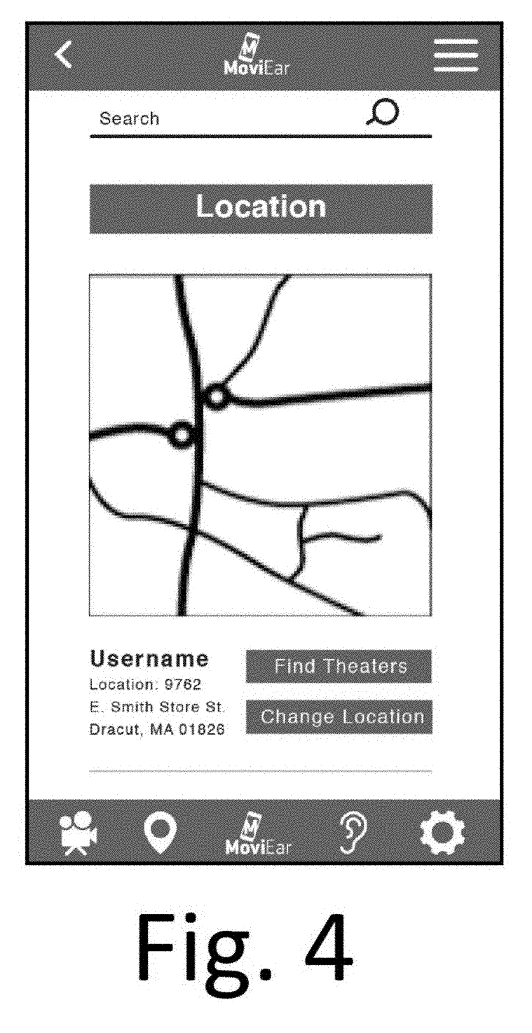

The system and application 1 lets a user search for the theater near the user's location as shown in the location sample screen in FIG. 4. The system 1 uses GPS technology. When a user selects a theater a location map is shown.

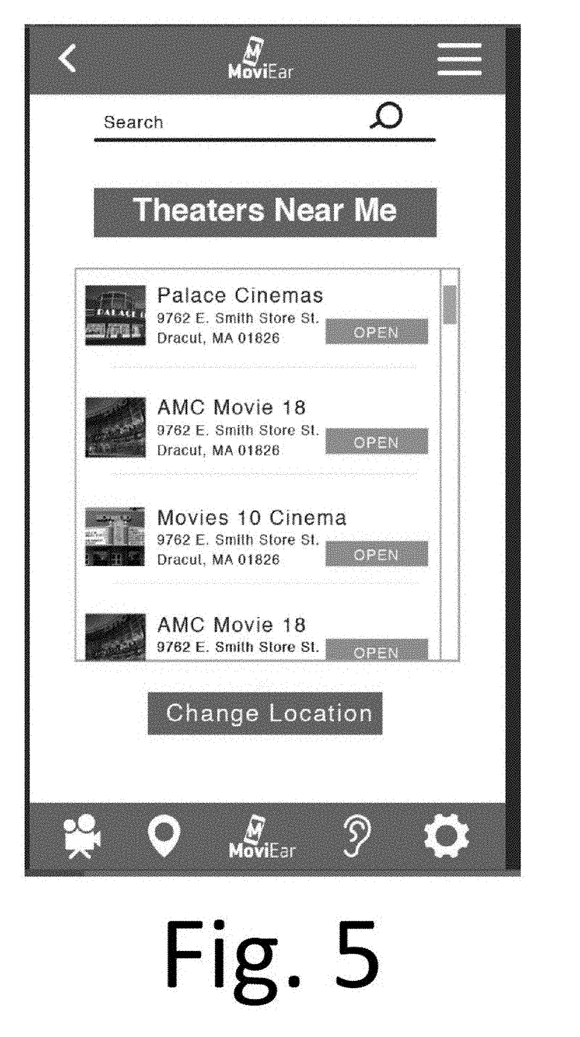

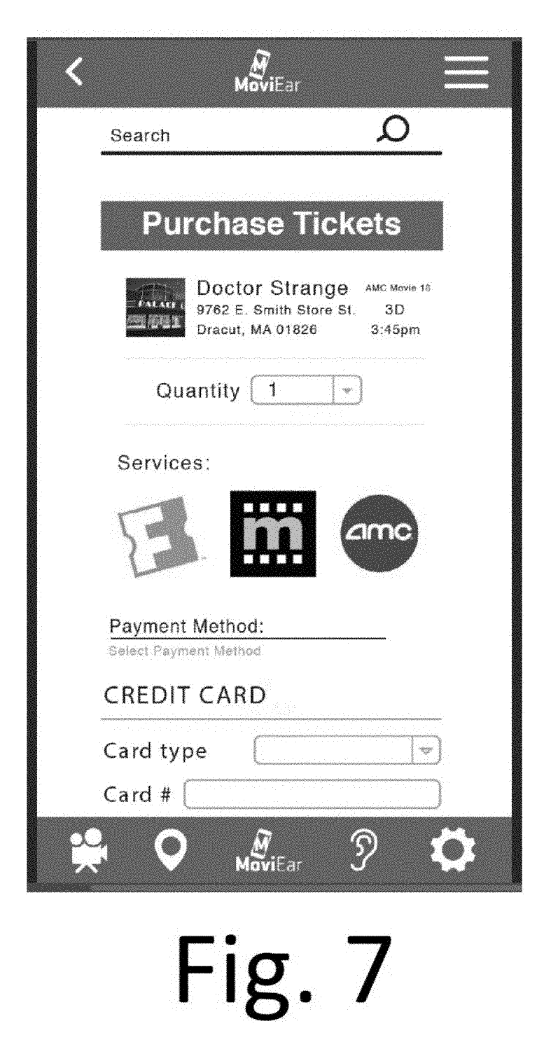

Once a theater is chosen the user will have the option to choose a movie that is showing at that theater and the time to view the movie as shown in FIG. 5. The user will have the option to purchase the tickets for that movie as shown in the purchase tickets screen as shown in FIG. 7.

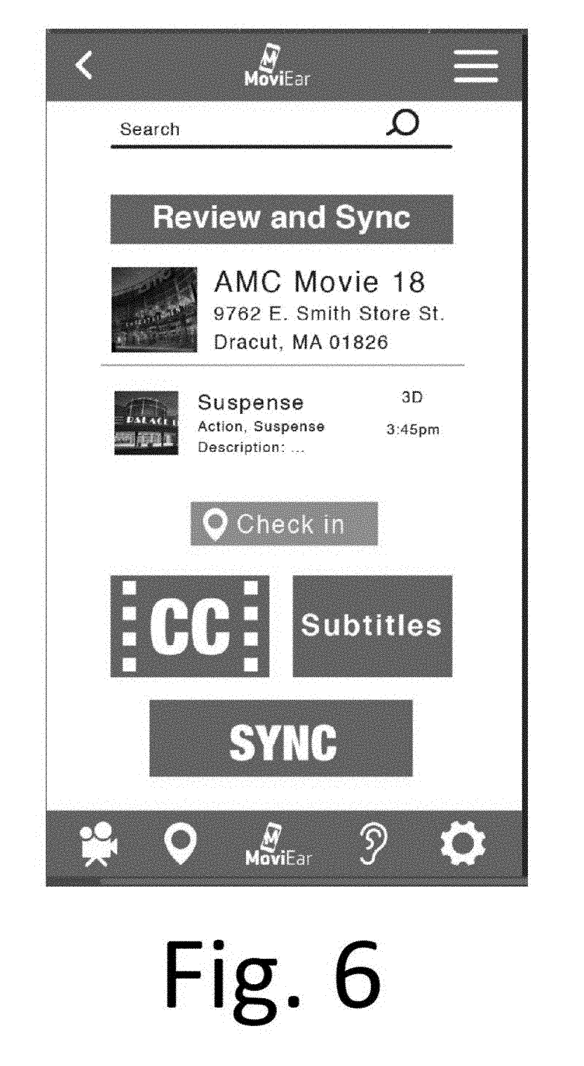

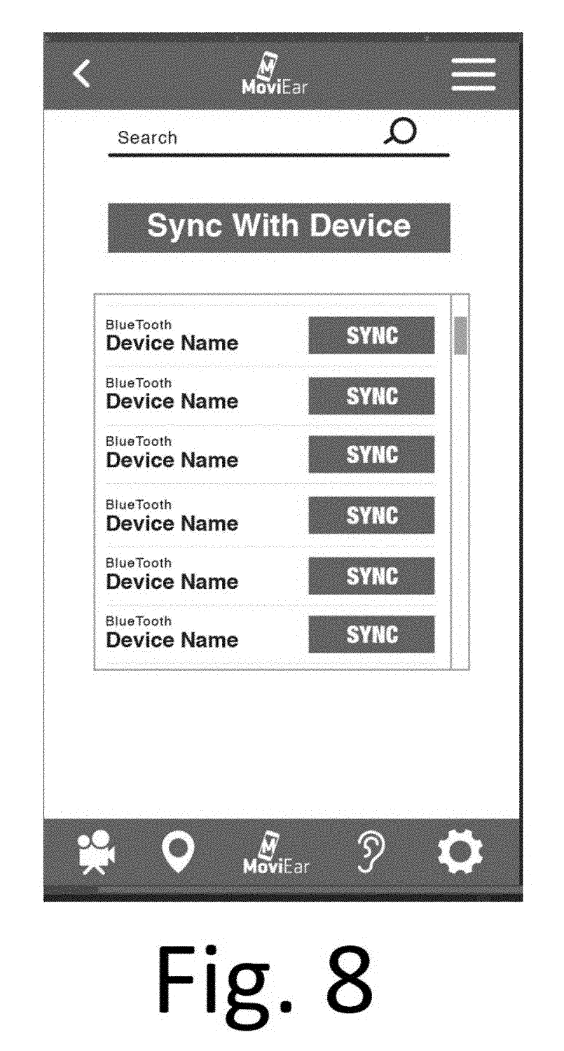

FIG. 6 shows a sample sync option screen. The user can choose an option of using an increased sound, closed caption or subtitles on their smart phone 20 or tablet. The system 1 can utilize Bluetooth capabilities 450 to connect to audio within the theater 400. The system will have zero sound bleed from surrounding theaters. The phone 20 remains on silent mode and the screen is off to prevent disruptions. The system 1 can provide sound through headphones 25 connected to the smart phone or smart head phones or earplugs. FIG. 8 shows the sync with device function which always the user to choose the device to sync with.

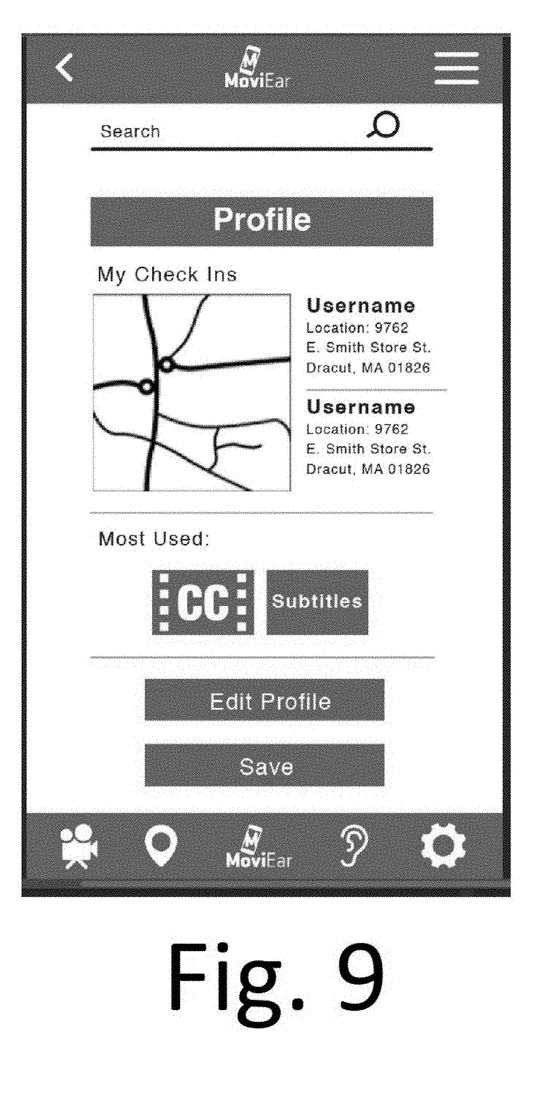

The user will set up their profile for the system using the profile screen as shown in FIG. 9. This would allow the user to set up their personal information and information about their favorite theaters and types of movies.

Advantages

The current invention eliminates the need to provide additional devices to patrons and reduces cost of lost or dysfunctional devices. It utilizes Bluetooth capabilities to connect to audio within the theater with zero sound bleed from surrounding theaters. The user's phone remains on silent mode and the screen is off to prevent disruptions.

Although the present invention has been described in considerable detail with reference to certain preferred versions thereof, other versions are possible. Therefore, the point and scope of the appended claims should not be limited to the description of the preferred versions contained herein. The system is not limited to any particular programming language, computer platform or architecture.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A system comprising;
having a system that resides in the non-transitory memory of a computing device;
providing and displaying information about the movies playing and proper sound data for hearing impaired for a movie being viewed where the data is synced with the movie.

2. A system according to claim 1 having a login screen.

3. A system according to claim 1 having the users set up profiles.

4. A system according to claim 1 showing the location of a movie theater.

5. A system according to claim 1 having a navigable map.

6. A system according to claim 1 having information about the movies in the movie theater.

7. A system according to claim 1 allowing the purchase of tickets.
